(19) United States
(12) Patent Application Publication
(10) Pub. No.: US 2025/0284306 A1
(43) Pub. Date: Sep. 11, 2025

(54) Bias Circuit and the Control Method thereof

(71) Applicant: Hangzhou Silicon-Magic Semiconductor Technology Co.,Ltd, Hangzhou (CN)

(72) Inventor: Tingqian CHEN, Hangzhou (CN)

(73) Assignee: Hangzhou Silicon-Magic Semiconductor Technology Co.,Ltd, Hangzhou (CN)

(21) Appl. No.: 19/066,184

(22) Filed: Feb. 28, 2025

(30) Foreign Application Priority Data
Mar. 5, 2024 (CN) 202410251046.4
Apr. 19, 2024 (CN) 202410469084.7

(51) Int. Cl. G05F 3/26

(52) U.S. Cl. CPC G05F 3/262

(57) ABSTRACT

A bias circuit having a first current source, a second current source, a first current mirror circuit, a second current mirror circuit, a third current mirror circuit and a fourth current mirror circuit. The first current mirror circuit has a first transistor and a second transistor. The first current mirror circuit and the second current mirror circuit are configured to guarantee equal voltages at the drain terminals and equal voltages at the source terminals of the first and second transistors, such that the first current mirror circuit has high precision and the bias circuit has a large input voltage range.

### CROSS-REFERENCE TO RELATED APPLICATION

This application claims the benefit of Chinese patent application No. 202410251046.4, filed on Mar. 5, 2024, and Chinese patent application No. 202410469084.7, filed on Apr. 18, 2024, which are incorporated herein by reference in its entirety.

### TECHNICAL FIELD

The present disclosure relates to semiconductor technology and in particular to an electric circuit for providing a bias voltage and the control method thereof.

### BACKGROUND

In a traditional comparator, a bias circuit with two diode connected transistors coupled in series provides two bias voltages. However, since the two transistors are coupled in series and each transistor is in a diode configuration, the input voltage range for a power supply voltage of the bias circuit is limited. When the power supply voltage of the bias circuit is low, the accuracy and performance of the bias circuit will be affected.

### SUMMARY

It is an object of the present disclosure to provide a bias circuit providing precise and stable bias voltages.

The embodiments of the present invention are directed to a bias circuit includes a first current source, a second current source, a first current mirror circuit, a second current mirror circuit, a third current mirror circuit and a fourth current mirror circuit. The first current mirror circuit has a first terminal, a second terminal, a third terminal and a fourth terminal. The first terminal and the second terminal of the first mirror circuit are coupled to a power bus. The second current mirror circuit has a first terminal, a second terminal, a third terminal and a fourth terminal. The first terminal of the second current mirror circuit is coupled to the third terminal of the first current mirror circuit. The second terminal of the second current mirror circuit is coupled to the fourth terminal of the first current mirror circuit. The third terminal of the second current mirror circuit is coupled to the first current source. The fourth terminal of the second current mirror circuit is coupled to the second current source. The third current mirror circuit has a first terminal, a second terminal, a third terminal, a fourth terminal and a fifth terminal. The first terminal of the third current mirror circuit is coupled to the fourth terminal of the first current mirror circuit. The second terminal of the third current mirror circuit is coupled to the power bus. The fifth terminal of the third current mirror circuit provides a first bias voltage. The fourth current mirror circuit has a first terminal, a second terminal, a third terminal, a fourth terminal and a fifth terminal. The first terminal of the fourth current mirror circuit is coupled to the third terminal of the third current mirror circuit. The second terminal of the fourth current mirror circuit is coupled to the fourth terminal of the third current mirror circuit. The third terminal and the fourth terminal of the fourth current mirror circuit are coupled to a ground reference. The fifth terminal provides a second bias voltage.

The embodiments of the present invention are directed to a bias circuit includes a first current source, a second current source, a first current mirror circuit, a second current mirror circuit, a third current mirror circuit and a fourth current mirror circuit. The first current mirror circuit has a first terminal, a second terminal, a third terminal and a fourth terminal. The first terminal and the second terminal of the first current mirror circuit are coupled to a ground reference. The second current mirror circuit has a first terminal, a second terminal, a third terminal and a fourth terminal. The first terminal of the second current mirror circuit is coupled to the third terminal of the first current mirror circuit. The second terminal of the second current mirror circuit is coupled to the fourth terminal of the first current mirror circuit. The third terminal of the second current mirror circuit is coupled to the first current source, and the fourth terminal of the second current mirror circuit is coupled to the second current source. The third current mirror circuit has a first terminal, a second terminal, a third terminal, a fourth terminal and a fifth terminal. The first terminal of the third current mirror circuit is coupled to the fourth terminal of the first current mirror circuit. The second terminal of the third current mirror circuit is coupled to the ground reference. The fifth terminal of the third current mirror circuit provides a first bias voltage. The fourth current mirror circuit has a first terminal, a second terminal, a third terminal, a fourth terminal and a fifth terminal. The first terminal of the fourth current mirror circuit is coupled to the third terminal of the third current mirror circuit. The second terminal of the fourth current mirror circuit is coupled to the fourth terminal of the third current mirror circuit. The third terminal and the fourth terminal of the fourth current mirror circuit are coupled to a power bus. The fifth terminal of the fourth current mirror circuit provides a second bias voltage.

### BRIEF DESCRIPTION OF FIGURES

The present disclosure can be further understood with reference to following detailed description and appended drawings, wherein like elements are provided with like reference numerals. These drawings are only for illustration purpose, thus may only show part of the devices and are not necessarily drawn to scale. It is obvious that the drawings described below are some implementations of the present disclosure, and those skilled in the art would also obtain other drawings on the basis of these drawings, without involving any inventive skill.

FIG. 1 schematically shows a bias circuit in accordance with an embodiment of the present disclosure.

FIG. 2 schematically show a bias circuit in accordance with an embodiment of the present disclosure.

FIG. 3 schematically shows a bias circuit in accordance with an embodiment of the present disclosure.

FIG. 4 schematically shows a bias circuit in accordance with an embodiment of the present disclosure.

The use of the same reference label in different drawings indicates the same or like components.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

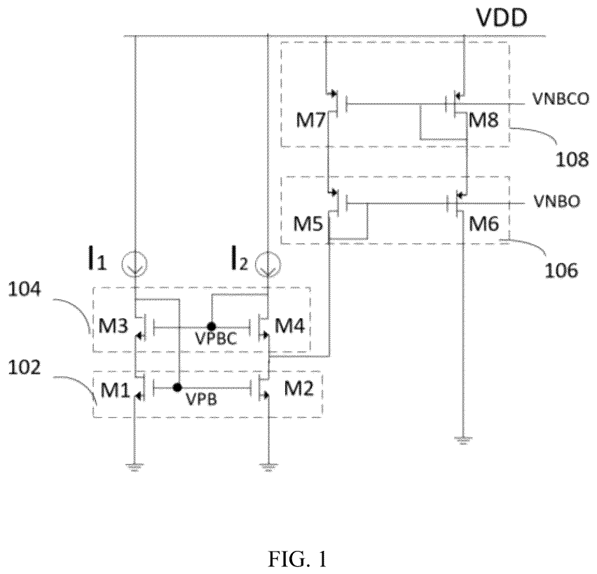

FIG. 1 schematically shows a bias circuit in accordance with an embodiment of the present disclosure. The bias circuit includes a reference voltage generating circuit 10 and a bias voltage generating circuit 20. The reference voltage generating circuit 10 provides a reference voltage Vref to the bias voltage generating circuit 20. The bias voltage generating circuit 20 provides a first bias voltage VNBCO and a second bias voltage VNBO. The first bias voltage VNBCO is generated based on the reference voltage Vref, and the second bias voltage VNBO is generated based on the first bias voltage VNBCO. The first bias voltage VNBCO is higher than the second bias voltage VNBO. When the second bias voltage VNBO varies, a current lout flowing to the bias voltage generating circuit 20 varies accordingly, such that for regulating the second bias voltage VNBO.

In one embodiment, when the second bias voltage VNBO decreases, the current lout flowing to the bias voltage generating circuit 20 increases; when the second bias voltage VNBO increases, the current lout flowing to the bias voltage generating circuit 20 decreases.

In the embodiments of the present disclosure, by the configuration of the reference voltage generating circuit 10 and the bias voltage generating circuit 20, the disturbance of the second bias voltage VNBO on the first bias voltage VNBCO is reduced.

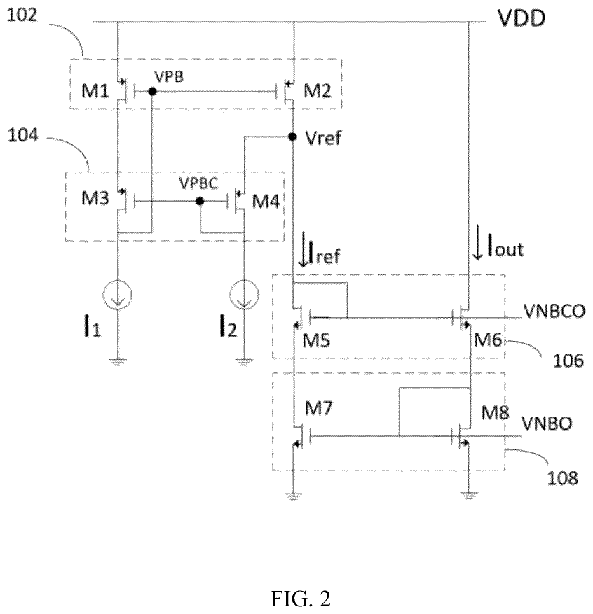

FIG. 2 schematically shows a bias circuit in accordance with an embodiment of the present disclosure. In the embodiment of FIG. 2, the reference voltage generating circuit 10 includes a first current mirror circuit 102, a second current mirror circuit 104, a first current source 11 and a second current source 12. The bias voltage generating circuit 20 includes a third current mirror circuit 106 and a fourth current mirror circuit 108.

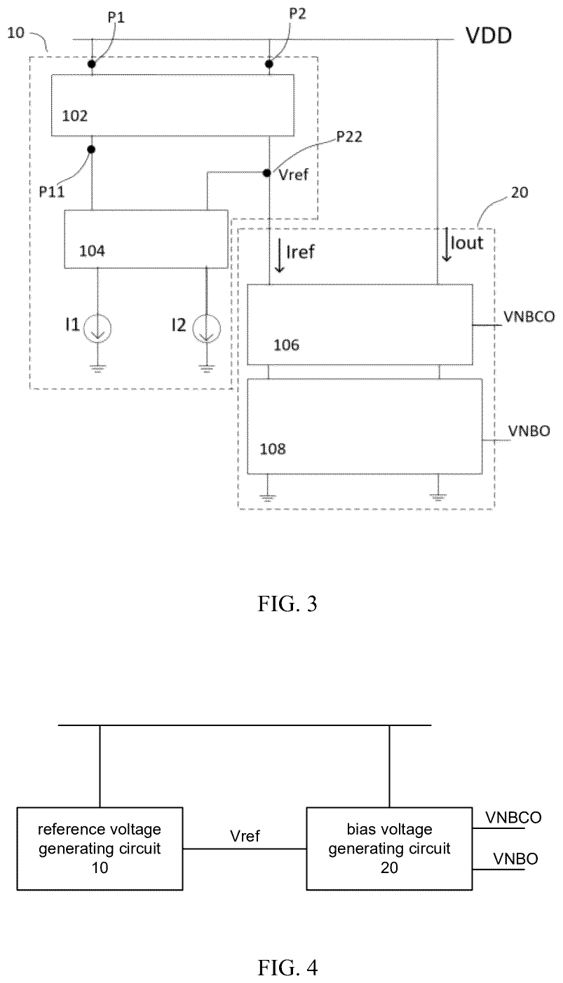

The first current mirror circuit 102 has a first input terminal P1 (also referred as a first terminal), a second input terminal P2 (also referred as a second terminal), a first output terminal P11 (also referred as a third terminal), and a second output terminal P22 (also referred as a fourth terminal). The first current mirror circuit 102 provides the reference voltage Vref. The second current mirror circuit 104 is connected to the first current mirror circuit 102. The first current source 11 and the second current source 12 are connected to the second current mirror circuit 104. Based on a current provided by the first current source 11, the second current mirror circuit 104 provides a first driving voltage VPB (present in FIGS. 3 and 4) to the first current mirror circuit 102. Based on a current provided by the second current source 12, the second current mirror circuit 104 obtains a second driving voltage VPBC (present in FIGS. 3 and 4). The third current mirror circuit 106 is connected to the first current mirror circuit 102 and the second current mirror circuit 104. Based on the reference voltage Vref, the third current mirror circuit 106 provides the first bias voltage VNBCO. The fourth current mirror circuit 108 is connected to the third current mirror circuit 106. Based on the first bias voltage VNBCO, the fourth current mirror circuit 108 provides the second bias voltage.

In one embodiment, the first bias voltage VNBCO is equal to the reference voltage Vref. In one embodiment, the first bias voltage VNBCO is larger than the second bias voltage VNBO.

In one embodiment, the reference voltage Vref is provided at the second output terminal P22 of the first current mirror circuit 102. The voltage at the first output terminal P11 follows the reference voltage Vref at the second output terminal P22 by the second current mirror circuit 104. The current mirror circuit 102 has high precision since the first input terminal P1 and the second input terminal P2 are coupled together to have the same voltage, which is a power supply voltage VDD provided by a power bus, and also the first output terminal P11 and the second output terminal P22 have the same voltage, i.e., the reference voltage Vref. The high precision of the current mirror circuit 102 results in the large input voltage range for the power supply voltage VDD of the bias circuit in the embodiments of the present disclosure.

In one embodiment, when the second bias voltage VNBO varies, a current lout flowing through the third current mirror circuit 106 varies accordingly. Then the second bias voltage VNBO is regulated back to a previous voltage by the current lout.

In one embodiment, a current provided by the second output terminal P22 of the first current mirror circuit 102 is equal to the current of the second current source 12 plus a reference current Iref provided to the third current mirror circuit 106.

In the embodiments of the present disclosure, because the input terminals P1 and P2 have the same voltage, and the output terminals P11 and P22 also have the same voltage, the first current mirror circuit 102 has high precision. When the second bias voltage VNBO varies, the current lout flowing through the third current mirror circuit 106 varies accordingly to regulate the second bias voltage VNBO back, such that to reduce the disturbance of the second bias voltage VNBO on the first bias voltage VNBCO.

FIG. 3 schematically shows a bias circuit in accordance with an embodiment of the present disclosure. As shown in FIG. 3, the first current mirror circuit 102 includes a first transistor M1 and a second transistor M2. Each of the first transistor M1 and the second transistor M2 has a gate terminal, a drain terminal and a source terminal. The gate terminal of the first transistor M1 is coupled to the gate terminal of the second transistor M2. The source terminal of the first transistor M1 and the source terminal of the second transistor M2 are connected to the power bus to receive the power supply voltage VDD. The second current mirror circuit 104 includes a third transistor M3 and a fourth transistor M4. Each of the third transistor M3 and the fourth transistor M4 has a gate terminal, a drain terminal and a source terminal. The gate terminal of the third transistor M3 is coupled to the gate terminal of the fourth transistor M4. The drain terminal of the third transistor M3 is coupled to the first current source 11. The drain terminal of the fourth transistor M4 is coupled to the second current source 12.

The source terminal of the third transistor M3 is coupled to the drain terminal of the first transistor M1. The source terminal of the fourth transistor M4 is coupled to the drain terminal of the second transistor M2. The drain terminal of the third transistor M3 is coupled to the gate terminals of the first transistor M1 and the second transistor M2.

In one embodiment, the first transistor M1, the second transistor M2, the third transistor M3 and the fourth transistor M4 are field effect transistor, like P-type MOSFET (Metal Oxide Semiconductor Transistor).

The first current source 11 is also coupled to the gate terminals of the first transistor M1 and the second transistor M2, for generating the first driving voltage VPB at the gate terminals of the first transistor M1 and the second transistor M2. The second current source 12 is coupled to the gate terminals of the third transistor M3 and the fourth transistor M4, for generating the second driving voltage VPBC at the gate terminals of the third transistor M3 and the fourth transistor M4.

The third current mirror circuit 106 includes a fifth transistor M5 and a sixth transistor M6. Each of the fifth transistor M5 and the sixth transistor M6 has a gate terminal, a source terminal and a drain terminal. The gate terminal of the fifth transistor M5 is coupled to the gate terminal of the sixth transistor M6. The first bias voltage VNBCO is provided at the gate terminals of the fifth transistor M5 and the sixth transistor M6. The drain terminal of the fifth transistor M5 is coupled to the gate terminal of fifth transistor M5. The fourth current mirror circuit 108 includes a seventh transistor M7 and an eighth transistor M8. Each of the seventh transistor M7 and the eighth transistor M8 has a gate terminal, a source terminal and a drain terminal. The gate terminal of the seventh transistor M7 is coupled to the gate terminal of the eighth transistor M8. The second bias voltage VNBO is provided at the gate terminals of the seventh transistor M7 and the eighth transistor M8. The drain terminal of the eighth transistor M8 is coupled to gate terminal of the eighth transistor M8. The drain terminal of the seventh transistor M7 is coupled to the source terminal of the fifth transistor M5. The source terminal of the sixth transistor M6 is coupled to the drain terminal of the eighth transistor M8. The first bias voltage VNBCO is equal to the voltage at the gate terminal of the sixth transistor M6. The second bias voltage VNBO is equal to the voltage at the gate terminal of the eighth transistor M8.

In one embodiment, the fifth transistor M5, the sixth transistor M6, the seventh transistor M7 and the eighth transistor M8 are field effect transistor, like N-type MOSFET (Metal Oxide Semiconductor Transistor).

In one embodiment, a current flowing through the second transistor M2 is larger than a current flowing through the first transistor M1. In one embodiment, a width to length ratio of the second transistor M2 is multiple times greater than a width to length ratio of the first transistor M1. Accordingly, the current flowing through the second transistor M2 is multiple times greater than the current flowing through the first transistor M1.

During the operation of the bias circuit in FIG. 3, the first current source 11 determines the first driving voltage VPB at the gate terminals of the first transistor M1 and the second transistor M2. When the first driving voltage VPB is large enough, the first transistor M1 and the second transistor M2 are turned on. When the first transistor M1 is on, the reference voltage Vref at the drain terminal of the second transistor M2 is built up, which follows the voltage at the drain terminal of the first transistor M1. The first bias voltage VNBCO is equal to the reference voltage Vref as the gate terminal and the drain terminal of the fifth transistor M5 are connected. The second current source 12 determines the second driving voltage VPBC at the gate terminals of the third transistor M3 and the fourth transistor M4, to turn on the third transistor M3 and the fourth transistor M4.

The third transistor M3 and the fourth transistor M4 form a current mirror circuit, the voltage at the source terminal of the third transistor M3 is equal to the voltage at the source terminal of the fourth transistor M4. Since the drain terminal of the first transistor M1 is coupled to the source terminal of the third transistor M3, and the drain terminal of the second transistor M2 is coupled to the source terminal of the fourth transistor M4, the drain terminals of the first transistor M1 and the second transistor M2 have the same voltage, i.e., the reference voltage Vref is equal to the voltage at the drain terminal of the first transistor M1, which sets the first transistor M1 and the second transistor M2 in a same condition, i.e., both operate in linear region or in saturation region. As a result, the first transistor M1 and the second transistor M2 mirrors each other regardless of the change of the power supply voltage VDD, which guarantees that the first current mirror circuit 102 has high precision, and the bias circuit has the large input voltage range for the power supply voltage VDD.

The current flowing through the second transistor M2 flows to the fourth transistor M4 and the fifth transistor M5. The current of the fifth transistor M5 serves as the reference current Iref of the third current mirror circuit. The current lout of the third current mirror circuit 106 copies the reference current Iref.

When the second bias voltage VNBO varies, e.g., the second bias voltage VNBO decreases as a load of a post circuit driven by the second bias voltage VNBO increases, the voltage at the gate terminal of the eighth transistor M8 decreases. Consequently, the voltage at the source terminal of the sixth transistor M6 decreases. Then the current lout flowing through the sixth transistor M6 increases, which leads to an increase of the voltage at the gate terminal of the eighth transistor M8, i.e., the second bias voltage VNBO increases. As a result, the second bias voltage VNBO is self-regulated, and the disturbance of the second bias voltage VNBO on the first bias voltage VNBCO could be diminished.

FIG. 4 schematically shows a bias circuit in accordance with an embodiment of the present disclosure. The bias circuit in FIG. 4 includes the first current mirror circuit 102, the second current mirror circuit 104, the third current mirror circuit 106 and the fourth current mirror circuit 108. The first current mirror circuit 102 includes the first transistor M1 and the second transistor M2. The gate terminal of the first transistor M1 is coupled to the gate terminal of the second transistor M2. The source terminals of the first transistor M1 and the second transistor M2 are coupled to the ground reference. The second current mirror circuit 104 includes the third transistor M3 and the fourth transistor M4. The gate terminal of the third transistor M3 is coupled to the gate terminal of the fourth transistor M4. The drain terminal of the third transistor M3 is couple to the first current source 11. The drain terminal of the fourth transistor M4 is coupled to both the gate terminal of the fourth transistor M4 and the second current source 12.

The source terminal of the third transistor M3 is coupled to the drain terminal of the first transistor M1. The source terminal of the fourth transistor M4 is coupled to the drain terminal of the second transistor M2. The drain terminal of the third transistor M3 is coupled to the gate terminals of the first transistor M1 and the second transistor M2.

In one embodiment, the first transistor M1, the second transistor M2, the third transistor M3 and the fourth transistor M4 are field effect transistors, like N-type MOSFET.

The first current source 11 has one terminal coupled to the gate terminals of the first transistor M1 and the second transistor M2 for determining the first driving voltage VPB at the gate terminals of the first transistor M1 and the second transistor M2. The first current source 11 has the other terminal coupled to the power supply voltage VDD. The second current source 12 has one terminal coupled to the gate terminals of the third transistor M3 and the fourth transistor M4, for determining the second driving voltage VPBC at the gate terminals of the third transistor M3 and the fourth transistor M4. The second current source 12 has the other terminal coupled to the power supply voltage VDD.

The third current mirror circuit 106 includes the fifth transistor M5 and the sixth transistor M6. The gate terminal of the fifth transistor M5 is coupled to the gate terminal of the sixth transistor M6. The first bias voltage VNBCO is provided at the gate terminals of the fifth transistor M5 and the sixth transistor M6. The drain terminal of the fifth transistor M5 is coupled to the gate terminal of fifth transistor M5. The fourth current mirror circuit 108 includes the seventh transistor M7 and the eighth transistor M8. The gate terminal of the seventh transistor M7 is coupled to the gate terminal of the eighth transistor M8. The second bias voltage VNBO is provided at the gate terminals of the seventh transistor M7 and the eighth transistor M8. The drain terminal of the eighth transistor M8 is coupled to gate terminal of the eighth transistor M8. The source terminals of the seventh transistor M7 and the eighth transistor M8 are coupled to the power bus to receive the power supply voltage VDD.

The source terminal of the fifth transistor M5 is coupled to the drain terminal of the seventh transistor M7. The source terminal of the sixth transistor M6 is coupled to the drain terminal of the eighth transistor M8. The drain terminal of the third transistor M3 is coupled to the source terminals of the first transistor M1 and the second transistor M2. The first bias voltage VNBCO is equal to the voltage at the gate terminal of the sixth transistor M6. The second bias voltage VNBO is equal to the voltage at the gate terminal of the eighth transistor M8.

In one embodiment, the fifth transistor M5, the sixth transistor M6, the seventh transistor M7 and the eighth transistor M8 are field effect transistors, like P-type MOSFET (Metal Oxide Semiconductor Transistor).

While various embodiments have been described above to illustrate the bias circuit and the control method of the present disclosure, it should be understood that they have been presented by way of example only, and not limitation. Rather, the scope of the present disclosure is defined by the following claims and includes combinations and sub-combinations of the various features described above, as well as variations and modifications thereof, which would occur to persons skilled in the art upon reading the foregoing description.

1. A bias circuit, comprising:
a first current source;
a second current source;
a first current mirror circuit, having a first terminal, a second terminal, a third terminal and a fourth terminal, wherein the first terminal and the second terminal are coupled to a power bus;
a second current mirror circuit, having a first terminal, a second terminal, a third terminal and a fourth terminal, wherein the first terminal is coupled to the third terminal of the first current mirror circuit, the second terminal is coupled to the fourth terminal of the first current mirror circuit, the third terminal is coupled to the first current source, and the fourth terminal is coupled to the second current source;
a third current mirror circuit, having a first terminal, a second terminal, a third terminal, a fourth terminal and a fifth terminal, wherein the first terminal is coupled to the fourth terminal of the first current mirror circuit, the second terminal is coupled to the power bus, the fifth terminal provides a first bias voltage; and
a fourth current mirror circuit, having a first terminal, a second terminal, a third terminal, a fourth terminal and a fifth terminal, wherein the first terminal is coupled to the third terminal of the third current mirror circuit, the second terminal is coupled to the fourth terminal of the third current mirror circuit, the third terminal and the fourth terminal are coupled to a ground reference, and the fifth terminal provides a second bias voltage.

2. The bias circuit of claim 1, wherein the first current mirror circuit comprises:
a first transistor, having a gate terminal, a source terminal and a drain terminal; and
a second transistor, having a gate terminal, a source terminal and a drain terminal;
wherein the gate terminal of the first transistor is coupled to the gate terminal of the second transistor, the source terminals of the first transistor and the second transistor are coupled to the power bus, the drain terminal of the first transistor is coupled to the third terminal of the first current mirror circuit, and the drain terminal of the second transistor is coupled to the fourth terminal of the first current mirror circuit.

3. The bias circuit of claim 2, wherein a width to length ratio of the second transistor is multiple times greater than a width to length ratio of the first transistor.

4. The bias circuit of claim 2, wherein a voltage at the drain terminal of the first transistor is equal to a voltage at the drain terminal of the second transistor.

5. The bias circuit of claim 2, wherein the second current mirror circuit comprises:
a third transistor, having a gate terminal, a source terminal and a drain terminal; and
a fourth transistor, having a gate terminal, a source terminal and a drain terminal;
wherein the gate terminal of the third transistor is coupled to the gate terminal of the fourth transistor, the source terminal of the third transistor is coupled to the drain terminal of the first transistor, and the drain terminal of the third transistor is coupled to the first current source and the gate terminal of the first transistor;
and wherein the source terminal of the fourth transistor is coupled to the drain terminal of the second transistor, and the drain terminal of the fourth transistor is coupled to the gate terminal of the fourth transistor and the second current source.

6. The bias circuit of claim 5, wherein the first transistor, the second transistor, the third transistor and the fourth transistor comprise P-type MOSFET (Metal Oxide Semiconductor Transistor).

7. The bias circuit of claim 1, wherein the third current mirror circuit comprises:
a fifth transistor, having a gate terminal, a source terminal and a drain terminal; and
a sixth transistor, having a gate terminal, a source terminal and a drain terminal;
wherein the gate terminal of the fifth transistor is coupled to the gate terminal of the sixth transistor and the drain terminal of the fifth transistor, the drain terminal of the fifth transistor is coupled to the fourth terminal of the first current mirror circuit, the source terminal of the fifth transistor is coupled to the third terminal of the third current mirror circuit; and
wherein the drain terminal of the sixth transistor is coupled to the power bus, the source terminal of the sixth transistor is coupled to the fourth terminal of the third current mirror circuit, and the first bias voltage is provided at the gate terminal of the sixth transistor.

8. The bias circuit of claim 7, wherein the fourth current mirror circuit comprises:
a seventh transistor, having a gate terminal, a source terminal and a drain terminal; and
an eighth transistor, having a gate terminal, a source terminal and a drain terminal;
wherein the gate terminal of the seventh transistor is coupled to the gate terminal of the eighth transistor, the drain terminal of the seventh transistor is coupled to the source terminal of the fifth transistor, and the source terminal of the seventh transistor is coupled to the ground reference; and
wherein the drain terminal of the eighth transistor is coupled to the gate terminal of the eighth transistor and the source terminal of the sixth transistor, the source terminal of the eighth transistor is coupled to the ground reference, and the second bias voltage is provided at the gate terminal of eighth transistor.

9. The bias circuit of claim 8, wherein the fifth transistor, the sixth transistor, the seventh transistor and the eighth transistor comprise N-type MOSFET (Metal Oxide Semiconductor Transistor).

10. A bias circuit, comprising:
a first current source;
a second current source;
a first current mirror circuit, having a first terminal, a second terminal, a third terminal and a fourth terminal, wherein the first terminal and the second terminal are coupled to a ground reference;
a second current mirror circuit, having a first terminal, a second terminal, a third terminal and a fourth terminal, wherein the first terminal is coupled to the third terminal of the first current mirror circuit, the second terminal is coupled to the fourth terminal of the first current mirror circuit, the third terminal is coupled to the first current source, and the fourth terminal is coupled to the second current source;
a third current mirror circuit, having a first terminal, a second terminal, a third terminal, a fourth terminal and a fifth terminal, wherein the first terminal is coupled to the fourth terminal of the first current mirror circuit, the second terminal is coupled to the ground reference, and the fifth terminal provides a first bias voltage; and
a fourth current mirror circuit, having a first terminal, a second terminal, a third terminal, a fourth terminal and a fifth terminal, wherein the first terminal is coupled to the third terminal of the third current mirror circuit, the second terminal is coupled to the fourth terminal of the third current mirror circuit, the third terminal and the fourth terminal are coupled to a power bus, and the fifth terminal provides a second bias voltage.

11. The bias circuit of claim 10, wherein the first current mirror circuit comprises:
a first transistor, having a gate terminal, a source terminal and a drain terminal; and
a second transistor, having a gate terminal, a source terminal and a drain terminal;
wherein the gate terminal of the first transistor is coupled to the gate terminal of the second transistor, the source terminals of the first transistor and the second transistor are coupled to the ground reference, the drain terminal of the first transistor is coupled to the third terminal of the first current mirror circuit, and the drain terminal of the second transistor is coupled to the fourth terminal of the first current mirror circuit.

12. The bias circuit of claim 11, wherein a width to length ratio of the second transistor is multiple times greater than a width to length ratio of the first transistor.

13. The bias circuit of claim 11, wherein a voltage at the drain terminal of the first transistor is equal to a voltage at the drain terminal of the second transistor.

14. The bias circuit of claim 11, wherein the second current mirror circuit comprises:
a third transistor, having a gate terminal, a source terminal and a drain terminal; and
a fourth transistor, having a gate terminal, a source terminal and a drain terminal;
wherein the gate terminal of the third transistor is coupled to the gate terminal of the fourth transistor, the source terminal of the third transistor is coupled to the drain terminal of the first transistor, and the drain terminal of the third transistor is coupled to the first current source and the gate terminal of the first transistor;
and wherein the source terminal of the fourth transistor is coupled to the drain terminal of the second transistor, and the drain terminal of the fourth transistor is coupled to the gate terminal of the fourth transistor and the second current source.

15. The bias circuit of claim 14, wherein the first transistor, the second transistor, the third transistor and the fourth transistor comprise N-type MOSFET (Metal Oxide Semiconductor Transistor).

16. The bias circuit of claim 10, wherein the third current mirror circuit comprises:
a fifth transistor, having a gate terminal, a source terminal and a drain terminal; and
a sixth transistor, having a gate terminal, a source terminal and a drain terminal;
wherein the gate terminal of the fifth transistor is coupled to the gate terminal of the sixth transistor and the drain terminal of the fifth transistor, the drain terminal of the fifth transistor is coupled to the fourth terminal of the first current mirror circuit; and
wherein the drain terminal of the sixth transistor is coupled to the ground reference, the source terminal of the sixth transistor is coupled to the fourth terminal of the third current mirror circuit, and the first bias voltage is provided at the gate terminal of the sixth transistor.

17. The bias circuit of claim 16, wherein the fourth current mirror circuit comprises:
a seventh transistor, having a gate terminal, a source terminal and a drain terminal; and
an eighth transistor, having a gate terminal, a source terminal and a drain terminal;
wherein the gate terminal of the seventh transistor is coupled to the gate terminal of the eighth transistor, the drain terminal of the seventh transistor is coupled to the source terminal of the fifth transistor, and the source terminal of the seventh transistor is coupled to the power bus; and
wherein the drain terminal of the eighth transistor is coupled to the gate terminal of the eighth transistor and the source terminal of the sixth transistor, the source terminal of the eighth transistor is coupled to the power bus, and the second bias voltage is provided at the gate terminal of eighth transistor.

18. The bias circuit of claim 17, wherein the fifth transistor, the sixth transistor, the seventh transistor and the eighth transistor comprise P-type MOSFET (Metal Oxide Semiconductor Transistor).
